(19) United States
(12) Patent Application Publication
(10) Pub. No.: US 2014/0016914 A1
(43) Pub. Date: Jan. 16, 2014

(54) EDITING APPARATUS, EDITING METHOD, PROGRAM AND STORAGE MEDIUM

(71) Applicant: Sony Corporation, Tokyo (JP)

(72) Inventors: Hiroyuki Yasuda, Saitama (JP); Hideyuki Ichihashi, Tokyo (JP); Nodoka Tokunaga, Tokyo (JP)

(73) Assignee: Sony Corporation, Tokyo (JP)

(21) Appl. No.: 13/933,376

(22) Filed: Jul. 2, 2013

(30) Foreign Application Priority Data
Jul. 11, 2012 (JP) 2012-155711

(51) Int. Cl. H04N 9/87

(52) U.S. Cl. CPC H04N 9/87
USPC 386/278

(57) ABSTRACT

There is provided an editing apparatus including a story determination unit determining a story indicated by a time function as a reference to select an image from multiple candidate images, an evaluation value calculation unit calculating an evaluation value of each of the candidate images per selection time in the story, based on the story determined in the story determination unit and one or more feature values which are set for each of the multiple candidate images and indicate features of the candidate images, an image selection unit selecting an image per selection time from the candidate images, based on the evaluation value calculated in the evaluation value calculation unit, a candidate image correction unit correcting the selected candidate image based on the evaluation value, and an edit processing unit linking the image selected per selection time and the candidate image corrected based on the evaluation value, in chronological order.

### BACKGROUND

The present disclosure relates to an editing apparatus, an editing method, a program and a storage medium.

Recently, with a dramatic improvement of processing capabilities of computers such as a PC (Personal Computer), it is becoming possible to edit images (e.g. moving images/static images) in a practical processing time without using a special apparatus. Also, according to the above, for example, there are an increasing number of users who edit images on a personal basis or on a domestic basis. Here, to edit images, for example, various operations such as “image (material) classification,” “story determination,” “image selection” and “selection as to how to link images” are requested. Therefore, there is a need for automation of image edit.

In such a state, there is developed a technique of automatically editing an image. For example, Japanese Patent Laid-open No. 2009-153144 is provided as a technique of: extracting an event reflecting a flow of content indicated by a moving image, from the moving image; and automatically generating a digest image linking scenes reflecting the flow of the content. Also, following Japanese Patent Laid-open No. 2012-94949 discloses a technique of selecting an image corresponding to a story from multiple candidate images per selection time and editing the selected image.

### SUMMARY

In the case of performing an automatic edit using a moving image or static image and acquiring a final image, it is important to select a material image. In this case, when there is no image suitable as a material, it is assumed that it is difficult to perform an edit along a story.

Therefore, even in a case where there is no image optimal as a material, it is requested to enable an edit based on a story.

According to an embodiment of the present disclosure, there is provided an editing apparatus including a story determination unit determining a story indicated by a time function as a reference to select an image from multiple candidate images, an evaluation value calculation unit calculating an evaluation value of each of the candidate images per selection time in the story, based on the story determined in the story determination unit and one or more feature values which are set for each of the multiple candidate images and indicate features of the candidate images, an image selection unit selecting an image per selection time from the candidate images, based on the evaluation value calculated in the evaluation value calculation unit, a candidate image correction unit correcting the selected candidate image based on the evaluation value, and an edit processing unit linking the image selected per selection time and the candidate image corrected based on the evaluation value, in chronological order.

The candidate image correction unit may correct the selected candidate image in a case where the evaluation value is equal to or less than a predetermined value.

The candidate image correction unit may correct the selected candidate image in a manner that the evaluation value is equal to or less than a predetermined value.

The candidate image correction unit may correct a magnifying power of the selected candidate image in a manner that the evaluation value is equal to or less than a predetermined value.

The candidate image correction unit may correct a photographing time of the selected candidate image in a manner that the evaluation value is equal to or less than a predetermined value.

According to an embodiment of the present disclosure, there is provided an editing apparatus including a story determination unit determining a story indicated by a time function as a reference to select an image from multiple candidate images, an evaluation value calculation unit calculating an evaluation value of each of the candidate images per selection time in the story, based on the story determined in the story determination unit and one or more feature values which are set for each of the multiple candidate images and indicate features of the candidate images, an image selection unit selecting an image per selection time from the candidate images, based on the evaluation value calculated in the evaluation value calculation unit, a story correction unit correcting the story based on the evaluation value, and an edit processing unit linking the image selected per selection time in chronological order.

The story correction unit may correct the story in a case where the evaluation value is equal to or less than a predetermined value.

The story correction unit may correct the story based on a user operation.

The story correction unit may correct the story in a manner that the evaluation value is equal to or less than a predetermined value.

The evaluation value calculation unit may calculate, per selection time, a distance based on a feature value of the candidate image and an expectation value of the feature value of the candidate image as the evaluation value.

The image selection unit may select a candidate image in which the evaluation value per selection time is minimum, per selection time.

The editing apparatus may further include an image evaluation unit setting the feature value with respect to the candidate image, based on the candidate image.

In a case where the candidate image is a moving image having a reproduction time over a predetermined time, the image evaluation unit may divide the candidate image in a manner that the reproduction time falls within the predetermined time, and sets the feature value to each of the divided candidate images.

The story may be indicated by a time function using a feature value indicating a feature amount of an image.

According to an embodiment of the present disclosure, there is provided an editing method including determining a story indicated by a time function as a reference to select an image from multiple candidate images, calculating an evaluation value of each of the candidate images per selection time in the story, based on the story determined in the determination step and one or more feature values which are set for each of the multiple candidate images and indicate features of the candidate images, selecting an image per selection time from the candidate images, based on the evaluation value calculated in the calculation step, correcting the selected candidate image based on the evaluation value, and linking the image selected per selection time and the candidate image corrected based on the evaluation value, in chronological order.

According to an embodiment of the present disclosure, there is provided an editing method including determining a story indicated by a time function as a reference to select an image from multiple candidate images, calculating an evaluation value of each of the candidate images per selection time in the story, based on the story determined in the determination step and one or more feature values which are set for each of the multiple candidate images and indicate features of the candidate images, selecting an image per selection time from the candidate images, based on the evaluation value calculated in the calculation step, correcting the story based on the evaluation value, and linking the image selected per selection time in chronological order.

According to an embodiment of the present disclosure, there is provided a program for causing a computer to function as a unit determining a story indicated by a time function as a reference to select an image from multiple candidate images, a unit calculating an evaluation value of each of the candidate images per selection time in the story, based on the story determined in the determination step and one or more feature values which are set for each of the multiple candidate images and indicate features of the candidate images, a unit selecting an image per selection time from the candidate images, based on the evaluation value calculated in the calculation step, a unit correcting the selected candidate image based on the evaluation value, and a unit linking the image selected per selection time and the candidate image corrected based on the evaluation value, in chronological order.

According to an embodiment of the present disclosure, there is provided a program for causing a computer to function as a unit determining a story indicated by a time function as a reference to select an image from multiple candidate images, a unit calculating an evaluation value of each of the candidate images per selection time in the story, based on the story determined in the determination step and one or more feature values which are set for each of the multiple candidate images and indicate features of the candidate images, a unit selecting an image per selection time from the candidate images, based on the evaluation value calculated in the calculation step, a unit correcting the story based on the evaluation value, and a unit linking the image selected per selection time in chronological order.

According to an embodiment of the present disclosure, there is provided a computer-readable recording medium having a program recorded thereon, the program causing a computer to function as a unit determining a story indicated by a time function as a reference to select an image from multiple candidate images, a unit calculating an evaluation value of each of the candidate images per selection time in the story, based on the determined story and one or more feature values which are set for each of the multiple candidate images and indicate features of the candidate images, a unit selecting an image per selection time from the candidate images, based on the evaluation value calculated in the calculation step, a unit correcting the selected candidate image based on the evaluation value, and a unit linking the image selected per selection time and the candidate image corrected based on the evaluation value, in chronological order.

According to an embodiment of the present disclosure, there is provided a computer-readable recording medium having a program recorded thereon, the program causing a computer to function as a unit determining a story indicated by a time function as a reference to select an image from multiple candidate images, a unit calculating an evaluation value of each of the candidate images per selection time in the story, based on the determined story and one or more feature values which are set for each of the multiple candidate images and indicate features of the candidate images, a unit selecting an image per selection time from the candidate images, based on the evaluation value calculated in the calculation step, a unit correcting the story based on the evaluation value, and a unit linking the image selected per selection time in chronological order.

According to the embodiments of the present disclosure described above, even in a case where there is no image optimal as a material, it is requested to enable an edit based on a story.

### BRIEF DESCRIPTION OF THE DRAWINGS

FIG. 1 is a flowchart illustrating an example of processing according to an editing approach in an editing apparatus according to an embodiment of the present disclosure;

FIG. 2 is an explanatory diagram illustrating an example of feature values set for candidate images according to an embodiment of the present disclosure;

FIG. 3 is a schematic diagram illustrating an example of using two types of C1 and C2 as category (C) and scoring candidate images (or materials) A, B, C, D, E, F, and so on;

FIG. 4 is a characteristic diagram illustrating a story in a case where there are two categories of c1 and c2 as a category C;

FIG. 5 is a characteristic diagram illustrating a state overlapping FIG. 3 and FIG. 4;

FIG. 6 is a flowchart illustrating an example of story determination processing in an editing apparatus according to an embodiment of the present disclosure;

FIG. 7 is a flowchart illustrating an example of evaluation value calculation processing in an editing apparatus according to an embodiment of the present disclosure;

FIG. 8 is an explanatory diagram for explaining an example of image selection processing in an editing apparatus according to an embodiment of the present disclosure;

FIG. 9 is an explanatory diagram for explaining another example of image selection processing in an editing apparatus according to an embodiment of the present disclosure;

FIG. 10 is a schematic diagram illustrating a state of changing candidate images;

FIG. 11 is a schematic diagram illustrating a state of cropping and zooming up a screen of a candidate image F;

FIG. 12 is a flowchart illustrating an example of image selection processing in an editing apparatus according to an embodiment of the present disclosure;

FIG. 13 is a flowchart illustrating material change processing in step S502 in FIG. 12;

FIG. 14 is a schematic diagram illustrating an example of changing a story between selection time t=6 and selection time t=8;

FIG. 15 is a schematic diagram for explaining a procedure of changing a story using a graphical UI on a display screen;

FIG. 16 is a block diagram illustrating an example of a configuration of an editing apparatus according to an embodiment of the present disclosure; and

FIG. 17 is an explanatory diagram illustrating an example of a hardware configuration of an editing apparatus 100 according to an embodiment of the present disclosure.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Also, an explanation is given below in the following order.

1. Approach according to embodiment of the present disclosure

2. Control apparatus according to embodiment of the present disclosure

3. Program according to embodiment of the present disclosure

4. Storage medium recording program according to embodiment of the present disclosure

### (Approach According to Embodiment of the Present Disclosure)

Before explaining a configuration of an editing apparatus according to an embodiment of the present disclosure (which may be referred to as “editing apparatus 100” below), an editing approach of an image according to an embodiment of the present disclosure is explained. Here, the image according to an embodiment of the present disclosure denotes a static image or moving image. In the following, there is a case where a candidate image which can serve as an edit target image is referred to as “material.” Also, processing associated with the editing approach according to an embodiment of the present disclosure shown below can be interpreted as processing according to an editing method according to an embodiment of the present disclosure.

### [Outline of Editing Approach]

As described above, even if an automatic edit is performed using the related art or a story template, there may occur a case where it is not possible to select a candidate image matching a story. As described above, in a case where it is not possible to select a candidate image, since an incomplete image may be acquired as an edited image, it is not limited that the edited image serves as a user-desirable image.

Therefore, an editing apparatus 100 according to an embodiment of the present disclosure calculates the evaluation value of each candidate image per selection time, based on a story indicated by a time function and the feature value (i.e. score) set for each candidate image. Also, the editing apparatus 100 selects an image from the candidate images based on the evaluation values calculated per selection time. Subsequently, the editing apparatus 100 generates an edited image by linking selection images corresponding to images selected per selection time, in chronological order.

Here, the story according to an embodiment of the present disclosure denotes the direction of the final creation edited by the editing apparatus 100. The story is a reference to select an image from multiple candidate images and is represented by a time function (whose specific example is described later). Also, the selection time according to an embodiment of the present disclosure denotes the time to calculate evaluation values in the story. That is, the selection time according to an embodiment of the present disclosure denotes the time for the editing apparatus 100 to perform processing of selecting a candidate image along the story. Examples of the selection time include the elapsed time (e.g. represented by second, minute or hour) from the edit start time. Here, for example, the selection time according to an embodiment of the present disclosure may be defined in advance or adequately set by the user.

As described above, the editing apparatus 100 sequentially calculates an evaluation value per selection time, based on a story indicated by a time function and feature values set for story candidate images, and, for example, processes a candidate image of the minimum (or maximum) evaluation value (i.e. candidate image of higher evaluation) per selection time, as a selection image per selection time. Therefore, in the editing apparatus 100 according to an embodiment of the present disclosure, it is possible to prevent that the selection image in each selection time is not selected, which may be caused in a case where an automatic edit is performed using the related art or a story template. Therefore, the editing apparatus 100 can select an image corresponding to the story from multiple candidate images per selection time for image selection and edit the selected image.

Also, since the editing apparatus 100 selects a candidate image of high evaluation indicated by a calculated evaluation value (e.g. evaluation image of the minimum evaluation value or evaluation image of the maximum evaluation value) as a selection image from multiple candidate images, for example, even in a case where an edit is performed using a indefinitely large number of candidate images, it is possible to select a more suitable selection image along a story. Therefore, for example, even in a case where candidate images dynamically change like a case where images, which are arbitrarily added or deleted by multiple users in an image community site, are processed as candidate images, the editing apparatus 100 can select a more suitable selection image along a story from the candidate images.

Further, since the editing apparatus 100 uses a story indicated by a time function, for example, it is possible to extend or abridge a story according to the setting of selection time. By contrast with this, sine a story template is created by a human creator, it is difficult to automatically change the story template. That is, it is difficult to extend or abridge a story by adding a change to a story template, and, in a case where a story is extended or abridged using a story template, for example, it is requested to prepare multiple story templates and adequately change these story templates. Therefore, by using a story indicated by a time function, the editing apparatus 100 can extend or abridge the story in an easier manner than a case where, for example, a story template is used in which it is difficult to extend or abridge a story unless the used story template itself is changed. Therefore, by using a story indicated by a time function, the editing apparatus 100 can perform an image edit of higher general versatility.

### [Specific Example of Processing According to Editing Approach]

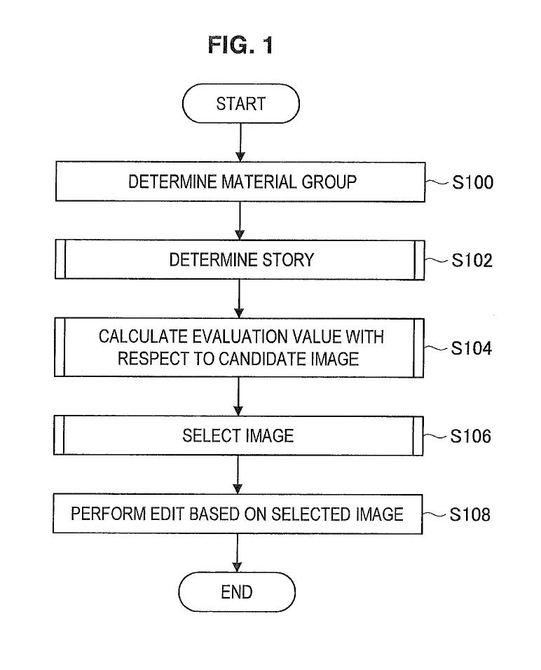

Next, an explanation is given to an example of processing to realize the above editing approach according to an embodiment of the present disclosure. FIG. 1 is a flowchart illustrating an example of processing according to an editing approach in the editing apparatus 100 according to an embodiment of the present disclosure.

The editing apparatus 100 determines a material group (S100). By performing processing in step S100, candidate images are determined. Here, the material group according to an embodiment of the present disclosure denotes candidate images grouped by a predetermined theme such as an athletic festival, a wedding ceremony and the sea. For example, the material group according to an embodiment of the present disclosure may be manually classified by the user or automatically classified by the editing apparatus 100 or an external apparatus such as a server by performing image processing.

The editing apparatus 100 performs processing in step S100 based on a user operation, for example. Here, to “perform processing based on a user operation” according to an embodiment of the present disclosure means that, for example, the editing apparatus 100 performs processing based on: a control signal corresponding to a user operation transferred from an operation unit (described later); an external operation signal corresponding to a user operation transmitted from an external operation device such as a remote controller; or an operation signal transmitted from an external apparatus via a network (or in a direct manner).

Also, the editing apparatus 100 according to an embodiment of the present disclosure may not perform the processing in step S100 illustrated in FIG. 1. In the above case, for example, the editing apparatus 100 selects a selection image from candidate images which are determined based on a user operation and are not specifically grouped.

The editing apparatus 100 extracts multiple focus points corresponding to the direction of an edited creation and assigns scores to candidate images in each of the focusing points. Also, the editing apparatus 100 sets a story by setting a score expectation value according to the time axis to define the creation. Subsequently, the editing apparatus 100 sequentially selects a candidate image having the most suitable score for the expectation value of the story based on the time axis of the creation.

To be more specific, first, candidate images are classified and focus points to define the direction of a creation are determined. Here, the focus points are referred to as “category (C).” The category includes, for example, an angle of view at the time of photographing an image, the number of photographed characters, the shutter speed, position information by GPS and the photographing time. Content of the category is not specifically limited or restricted. Also, scores of the candidate images are determined for each of the categories. The score may be a specific value or a value acquired by adequately performing processing such as normalization.

The editing apparatus 100 performs processing based on feature values set for the candidate images determined in above step S100, for example. Here, an explanation is given to the feature values set for the candidate images according to an embodiment of the present disclosure.

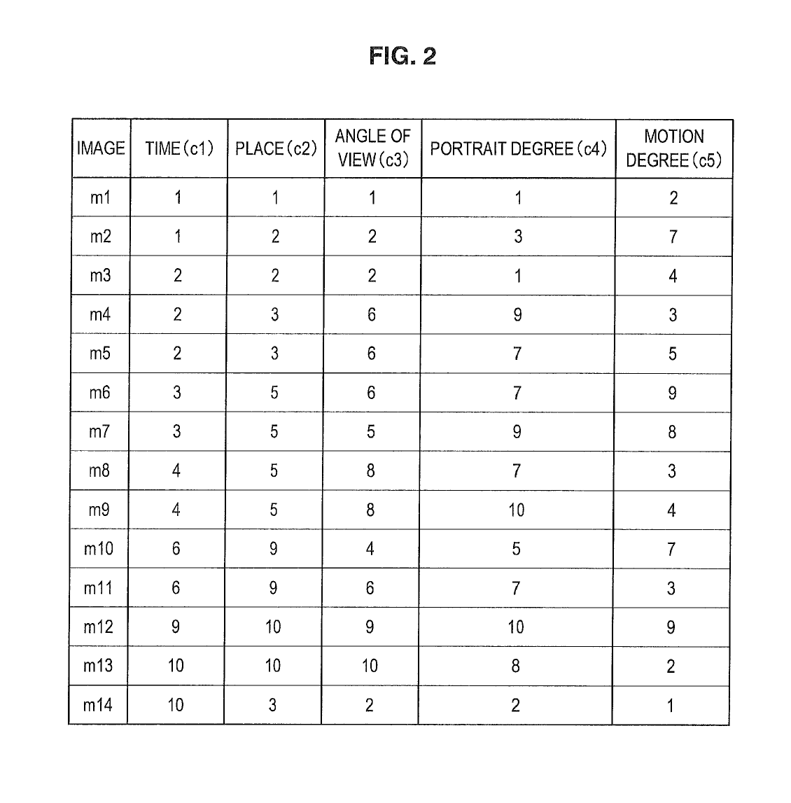

FIG. 2 is an explanatory diagram illustrating an example of feature amounts set for candidate images according to an embodiment of the present disclosure. Here, FIG. 2 illustrates an example of feature amounts set for images m1 to m14.

In the candidate images, the feature amounts (or so-called scores) are set for each category (C). Here, the category according to an embodiment of the present disclosure is a focus point in images to classify the images and define the direction of an edited image. For example, the category according to an embodiment of the present disclosure may be defined in advance or arbitrarily selected by the user from multiple category candidates. Examples of the category according to an embodiment of the present disclosure include: (c1) the time indicating a focus point based on an image photographing time; (c2) a place indicating a focus point based on an image photographing place; (c3) an angle of view indicating a focus point based on an angle of view; (c4) a portrait degree indicating a focus point based on whether an image subject is a particular one; and (c5) a motion degree (c5) indicating a focus point based on how much a photographing target or an imaging apparatus is moving (which may include panning or zoom). Here, the categories according to an embodiment of the present disclosure are not limited to the above. For example, the category according to an embodiment of the present disclosure may indicate a focus point based on the number of subjects, the shutter speed, and so on.

The editing apparatus 100 sets a feature value to each candidate image by performing an image analysis on each candidate image or referring to the metadata of each candidate image. For example, in the case of setting a feature value of the place (c2), the editing apparatus 100 sets the feature value of each candidate image in 10 steps according to the one-dimensional distance between a position of the apparatus acquired by using a GPS (Global Positioning System) or the like and the position at which each candidate image is photographed. In addition, in the case of setting a feature value of the image angle (c3), the editing apparatus 100 sets the feature value of each candidate image in 10 steps with a wide angle of 1 and a telephoto view of 10. In the case of setting a feature value of the portrait degree (c4), the editing apparatus 100 sets the feature value of each candidate image in 10 steps in which a candidate image having no subject is 1 and a candidate image with respect to a specific subject (e.g. the subject photographed at the center) is 10. Here, a method of setting feature values in the editing apparatus 100 is not limited to the above, and, for example, normalized feature values may be set by normalizing specific values.

Also, for example, in a case where a candidate image is a moving image having a reproduction time exceeding a predetermined time, the editing apparatus 100 can divide the candidate image by the time axis such that the reproduction time falls within the predetermined time. In the above case, the editing apparatus 100 sets the feature value to each divided candidate image. Here, for example, by referring to metadata of a candidate image, the editing apparatus 100 specifies the reproduction time of the candidate image, but a method of specifying the reproduction time of a candidate image according to an embodiment of the present disclosure is not limited to the above. Also, for example, the above predetermined period of time may be defined in advance or set based on a user operation.

As described, by dividing a candidate image by the time axis such that the reproduction time falls within a predetermined duration of time, and by setting the feature value to each divided candidate image, the editing apparatus 100 can set a feature value closer to a feature of the image as compared to a case where a feature value is set to the undivided candidate image.

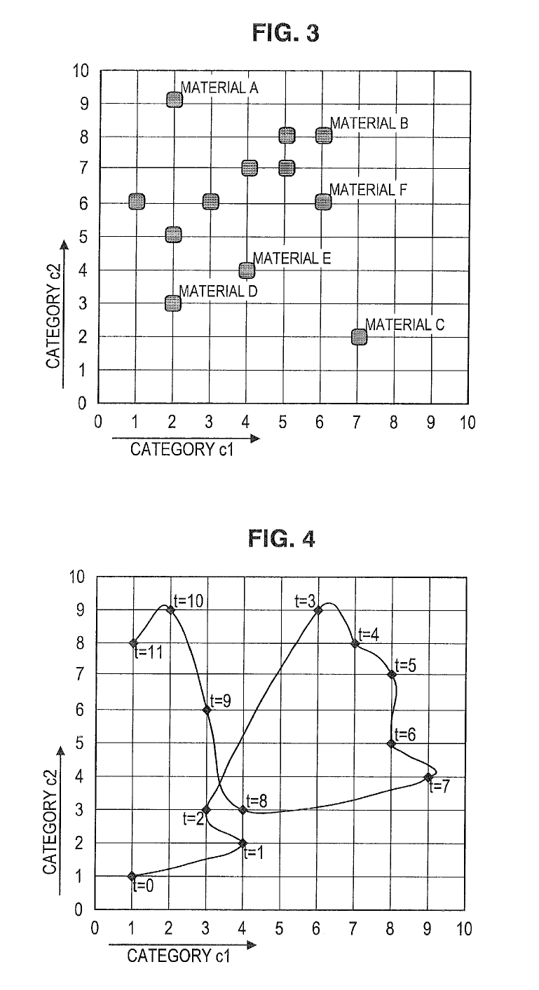

FIG. 3 illustrates an example where the category (C) contains two types of C1 and C2 and candidate images (or materials) A, B, C, D, E, F, and so on, are scored. In FIG. 3, the horizontal axis indicates feature values of category C1 and the vertical axis indicates feature values of category C2. Referring to candidate image A (or material A) as an example, the feature value of category C1 of candidate image A is “2” and the feature value of category C2 is “9.”

In the following explanation, it is assumed that categories focused as category C are expressed as C1, C2, and so on, and materials M are expressed as m1, m2, m3, and so on. Subsequently, a feature value of category (C) with respect to a candidate image (or material) M is expressed as “S(M,C).” For example, a feature value of category (c2) in image m1 illustrated in FIG. 2 is expressed as S(m1,c2)=1. Here, although FIG. 2 illustrates an example where multiple categories (C) are set to each candidate image; it is needless to say that only one category (C) may be set to each candidate image according to an embodiment of the present disclosure.

For example, the editing apparatus 100 sets the feature value to each candidate image as described above. Here, the editing apparatus 100 sets a feature value to an image determined as a candidate image in step S100, for example, but processing in the editing apparatus 100 according to an embodiment of the present disclosure is not limited to the above. For example, regardless of whether the processing in step S100 is performed, the editing apparatus 100 can perform processing of setting a feature value to an image that can serve as a candidate image. Here, for example, without performing processing of setting a feature value, the editing apparatus 100 can transmit a candidate image (or an image that can serve as a candidate image) to an external apparatus such as a server, and perform processing of calculating an evaluation value (described later) using a feature value set in the external apparatus.

With reference to FIG. 1 again, an explanation is given to an example of processing according to the editing approach in the editing apparatus 100 according to an embodiment of the present disclosure. When a material group is determined in step S100, the editing apparatus 100 determines a story (S102: story determination processing). For example, the editing apparatus 100 determines a story based on an operation signal corresponding to a user operation transferred from an operation unit (described later) or an external operation signal corresponding to a user operation transmitted from an external operation device such as a remote controller. Here, a method of determining a story in the editing apparatus 100 is not limited to the above. For example, in the case of receiving story information recording a story, which is transmitted from an external apparatus connected via a network (or in a direct manner), the editing apparatus 100 can determine the story indicated by the story information as a story to be used in processing (described later).

As described above, a story according to an embodiment of the present disclosure is a reference to select an image from multiple candidate images and is expressed by a time function. At a certain time, an expectation value (SX) of the score in each category on the story is defined. For example, an expectation value at time t in category c1 is expressed as “SX(cn,t).” The story is expressed as an expectation value, which is defined per category and changes over time. FIG. 4 is a characteristic diagram illustrating a story in a case where category C is formed with two of c1 and c2. As illustrated by a curve-line characteristic in FIG. 4, the expectation value per category changes over time (t=0 to 11). Thus, for example, the story is expressed using the expectation values (SX) of the feature values of candidate images in selection time t. In the following, an expectation value of category (cn) (where “n” is an integral number equal to or greater than 1) in a candidate image at selection time t is expressed as “SX(cn,t).”

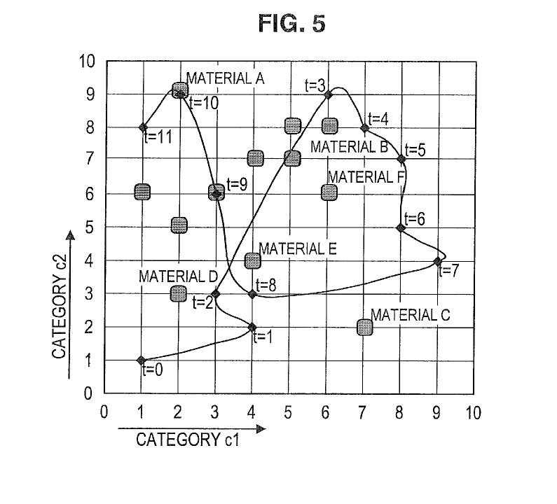

FIG. 5 is a characteristic diagram illustrating a state in which FIG. 3 and FIG. 4 are overlapped. According to FIG. 5, with respect to a story that changes along the time axis, it is possible to decide a material to be selected. In a case where there is no material matching the story, a material at the closest distance from the story may be selected.

Equations 1 to 3 below indicate an example of a story according to an embodiment of the present disclosure. Here, Equation 1 shows an example of a story to calculate Manhattan distance D(M)(t) based on both a feature value of candidate image (M) and an expectation value of the candidate image, as an evaluation value at selection time t. Here, in the specification, there is a case where the Manhattan distance as the evaluation value at selection time t is expressed as D(m,t). Also, Equations 2 and 3 indicate an example of an expectation value every category at selection time t. Here, N in Equations 1 and 3 denotes the number of candidate image categories.

$$\begin{matrix}D ( M ) ( t ) = {\sum }_{n = 1}^{N} \vert S ( M , cn ) - SX ( cn , t ) \vert ( t ) & Equation 1 \\ SX ( c 1 , t ) = \frac{1}{2} \cdot t & Equation 2 \\ SX ( ci , t ) = t , i = 2 … N & Equation 3\end{matrix}$$

Here, a story according to an embodiment of the present disclosure is not limited to those in above Equations 1 to 3. For example, the editing apparatus 100 may calculate a Manhattan distance as an evaluation value after weighting category (C) regardless of a real distance. Also, for example, the editing apparatus 100 can use a story based on a user operation by causing the user to input an expectation value with respect to category (C). Also, it is possible to present a graph (e.g. a graph with time in the horizontal axis and expectation values in the vertical axis) of a story corresponding to a time function to the user and use, as a story, the value of an expectation value which is changed based on a user operation and indicated by the graph.

### [Example of Story Determination Processing]

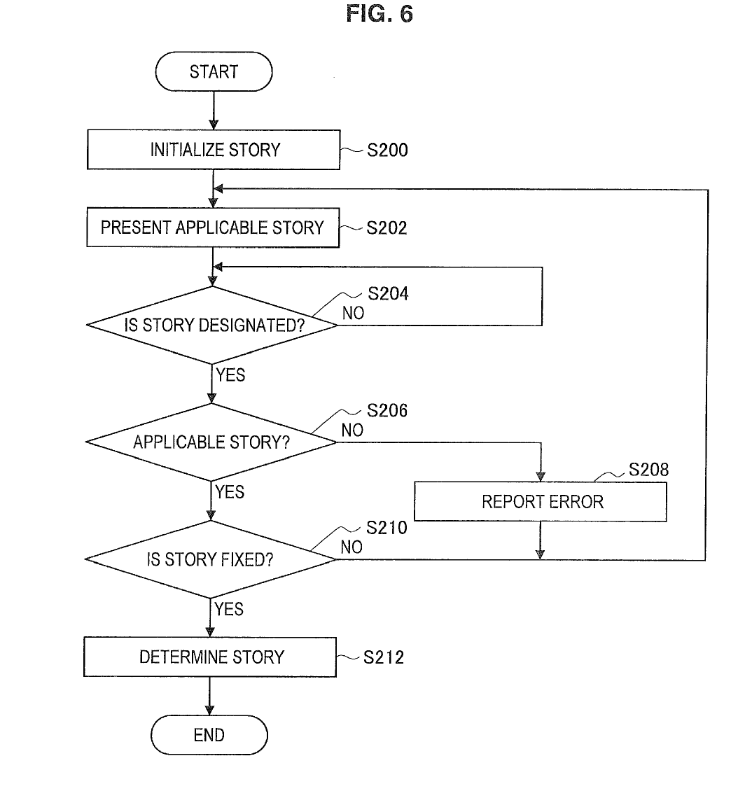

Here, story determination processing in the editing apparatus 100 according to an embodiment of the present disclosure is explained in more detail. FIG. 6 is a flowchart indicating an example of the story determination processing in the editing apparatus 100 according to an embodiment of the present disclosure. Here, FIG. 6 illustrates an example of processing in a case where the editing apparatus 100 determines a story based on an operation signal corresponding to a user operation or an external operation signal corresponding to a user operation. In the following, an explanation is given to an example in a case where the editing apparatus 100 determines a story based on an operation signal corresponding to a user operation.

The editing apparatus 100 initializes a story (S200). Here, processing in step S200 corresponds to, for example, processing of setting a story set in advance. For example, the editing apparatus 100 performs the processing in step S200 by reading story information stored in a storage unit (described later). Here, the processing in step S200 by the editing apparatus 100 is not limited to the above. For example, the editing apparatus 100 can perform communication with an external apparatus such as a server storing story information and perform the processing in step S200 using the story information acquired from the external apparatus.

When the story is initialized in step S200, the editing apparatus 100 presents an applicable story (S202). Here, the application story denotes a story that does not correspond to a story on which an error is displayed in step S208 (described later). That is, the story initialized in step S200 is presented in step S202.

When the story is presented in step S202, the editing apparatus 100 decides whether the story is designated (S204). The editing apparatus 100 performs the decision in step S204 based on an operation signal corresponding to a user operation, for example.

In a case where it is not decided that the story is not designated in step S204, the editing apparatus 100 does not advance the procedure until it is decided that a story is designated. Also, although it is not illustrated in FIG. 3, for example, in a case where an operation signal is not detected for a predetermined period of time after the processing in step S202 is performed, the editing apparatus 100 may terminate the story determination processing (so-called “time-out”). Also, in the above case, for example, the editing apparatus 100 reports the termination of the story determination processing to the user.

In a case where it is decided in step S204 that a story is designated, the editing apparatus 100 decides whether the designated story is an applicable story (S206). As described above, for example, the editing apparatus 100 can use a story based on a user operation by causing the user to input an expectation value with respect to category (C). In a case where an abnormal value is input by the user, the editing apparatus 100 decides that it is not an applicable story.

In a case where it is decided in step S206 that it is an applicable story, the editing apparatus 100 reports an error (S208). Subsequently, the editing apparatus 100 repeats the processing in step S202 therefrom. Here, for example, although the editing apparatus 100 reports an error visually and/or audibly by displaying an error screen on a display screen or outputting an error sound, the processing in step S208 by the editing apparatus 100 is not limited to the above.

Also, in a case where it is decided in step S206 that it is an applicable story, the editing apparatus 100 decides whether the story is fixed (S210). For example, the editing apparatus 100 displays a screen on a display screen to cause the user to select whether to fix the story, and performs the decision in step S210 based on an operation signal corresponding to a user operation.

In a case where it is not decided in step S210 that the story is fixed, the editing apparatus 100 repeats the processing in step S202 therefrom.

In a case where it is decided in step S210 that the story is fixed, the editing apparatus 100 determines the story designated in step S204 as a story used for processing (S212), thereby terminating the story determination processing.

The editing apparatus 100 determines a story by performing the processing illustrated in FIG. 6, for example. Here, it is needless to say that the story determination processing according to an embodiment of the present disclosure is not limited to the example illustrated in FIG. 6.

With reference to FIG. 1 again, an explanation is given to an example of processing according to the editing approach in the editing apparatus 100 according to an embodiment of the present disclosure. When a story is determined in step S102, then the editing apparatus 100 calculates an evaluation value with respect to a candidate image (S104: evaluation value calculation processing).

### [Example of Evaluation Value Calculation Processing]

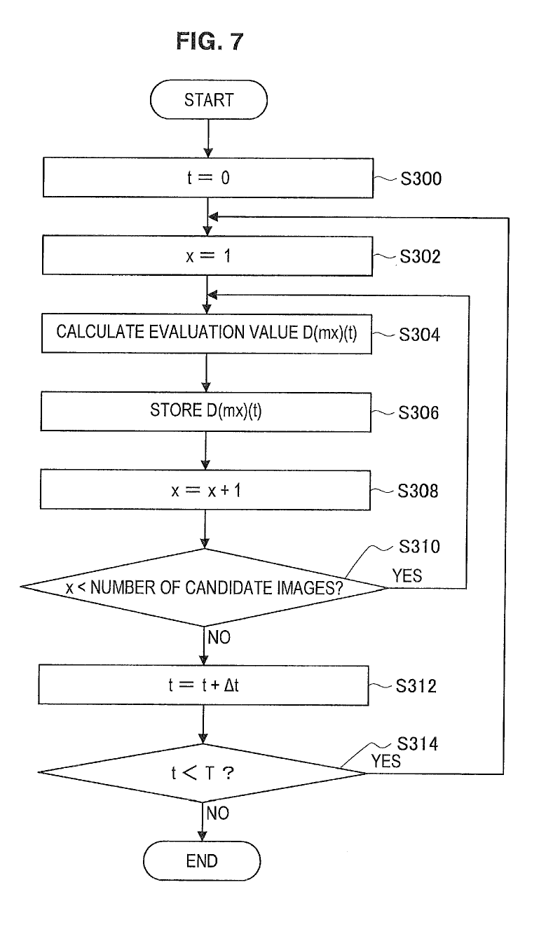

FIG. 7 is a flowchart illustrating an example of evaluation value calculation processing in the editing apparatus 100 according to an embodiment of the present disclosure. Here, FIG. 7 illustrates an example where the editing apparatus 100 calculates Manhattan distance D(M)(t) based on both a feature value of candidate image (M) and an expectation value of the candidate image in Equation 1, as an evaluation value at selection time t. In FIG. 7, an explanation is given with an assumption that each candidate image is expressed as mx (where “x” is an integral number equal to or more than 1) as illustrated in FIG. 2.

The editing apparatus 100 sets t=0 as a value of selection time t (S300) and sets x=0 as a value of “x” to define a candidate image for which an evaluation value is calculated (S302).

When the processing in step S302 is performed, the editing apparatus 100 calculates evaluation value D(mx)(t) with respect to the candidate image (mx) (S304). Here, the editing apparatus 100 calculates Manhattan distance D(mx)(t) as an evaluation value by using, for example, the expectation value fixed in Equation 1 and step S212 in FIG. 6.

When evaluation value D(mx)(t) is calculated in step S304, the editing apparatus 100 stores calculated evaluation value D(mx)(t) (S306). Subsequently, the editing apparatus 100 updates a value of “x” to “x+1” (S308).

When the value of “x” is updated in step S308, the editing apparatus 100 decides whether the value of “x” is smaller than the number of candidate images (S310). In a case where it is decided in step S310 that the value of “x” is smaller than the number of candidate images, since there is a candidate image for which an evaluation value is not calculated, the editing apparatus 100 repeats the processing in step S304 therefrom.

In a case where it is not decided in step S310 that the value of “x” is smaller than the number of candidate images, the editing apparatus 100 updates a value of “t” to “t+Δt” (S312). Here, Δt according to an embodiment of the present disclosure defines an interval of selection time t. In FIG. 7, although a case is illustrated where Δt is constant, Δt according to an embodiment of the present disclosure is not limited to the above. For example, Δt according to an embodiment of the present disclosure may be an inconstant value changed by the user or may be set at random by the editing apparatus 100.

When the value of “t” is updated in step S312, the editing apparatus 100 decides whether the value of “t” is smaller than total reproduction time T of an edited image (S314). Here, total reproduction time T according to an embodiment of the present disclosure may be a value defined in advance or a value set based on a user operation.

In a case where it is decided in step S314 that the value of “t” is smaller than total reproduction time T, the editing apparatus 100 repeats the processing in step S302 therefrom. Also, in a case where it is not decided in step S314 that the value of “t” is smaller than total reproduction time T, the editing apparatus 100 terminates the evaluation value calculation processing.

For example, by performing the processing in FIG. 7, the editing apparatus 100 calculates the evaluation value of each candidate image per selection time t. Here, it is needless to say that the evaluation value calculation processing according to an embodiment of the present disclosure is not limited to the example illustrated in FIG. 7.

With reference to FIG. 1 again, an explanation is given to an example of processing according to the editing approach in the editing apparatus 100 according to an embodiment of the present disclosure. When an evaluation value with respect to the candidate image is calculated in step S104, the editing apparatus 100 selects a selection image from candidate images based on the evaluation value (S106: image selection processing).

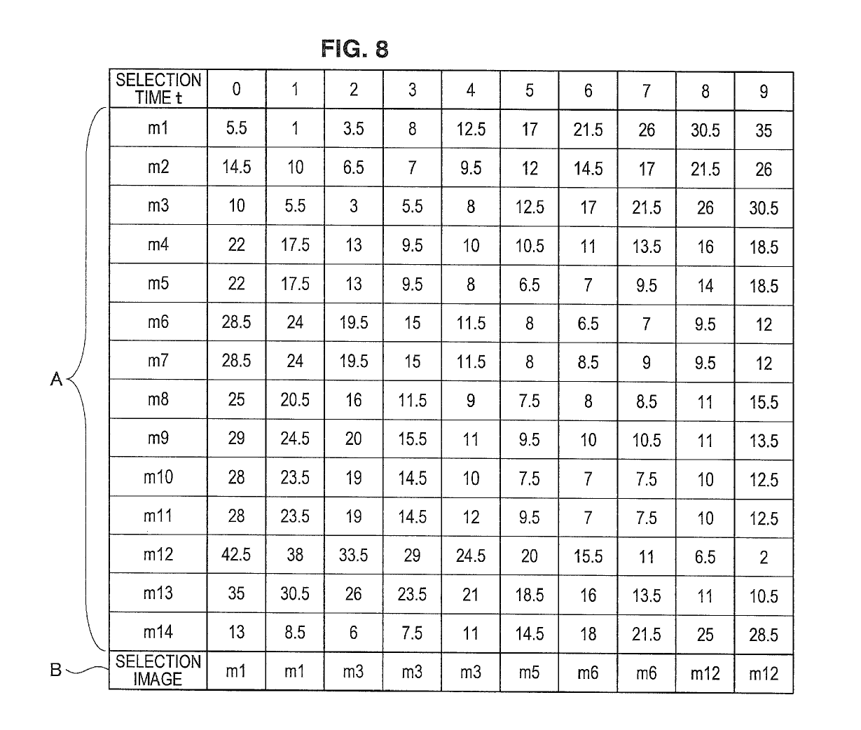

FIG. 8 is an explanatory diagram illustrating an example of image selection processing in the editing apparatus 100 according to an embodiment of the present disclosure. Here, FIG. 8 illustrates evaluation values (“A” illustrated in FIG. 8) calculated per selection time “t” and selection images selected per selection time “t” (“B” illustrated in FIG. 8) by applying the stories indicated by Equations 1 to 3 to the candidate images m1 to m14 illustrated in FIG. 2.

As illustrated in FIG. 8, in a case where Manhattan distance D(M)t is calculated as an evaluation value, a candidate image having the minimum evaluation value per selection time t is selected as a selection image. Here, the editing apparatus 100 according to an embodiment of the present disclosure is not limited to select the candidate image having the minimum evaluation value as a selection image but may select a candidate image having the maximum evaluation value as a selection image. That is, based on the evaluation values, the editing apparatus 100 selects a candidate image having a higher evaluation value as a selection image. Therefore, the editing apparatus 100 can select a more suitable candidate image along a story per selection time. Also, in a case where there are multiple candidate images having the minimum (or maximum) evaluation value, for example, the editing apparatus 100 may select a selection image from these multiple candidate images at random or select a selection image according to a candidate image priority defined in advance.

Here, the image selection processing in the editing apparatus 100 according to an embodiment of the present disclosure is not limited to processing in which the same candidate image is selected multiple times as a selection image, as illustrated in FIG. 8.

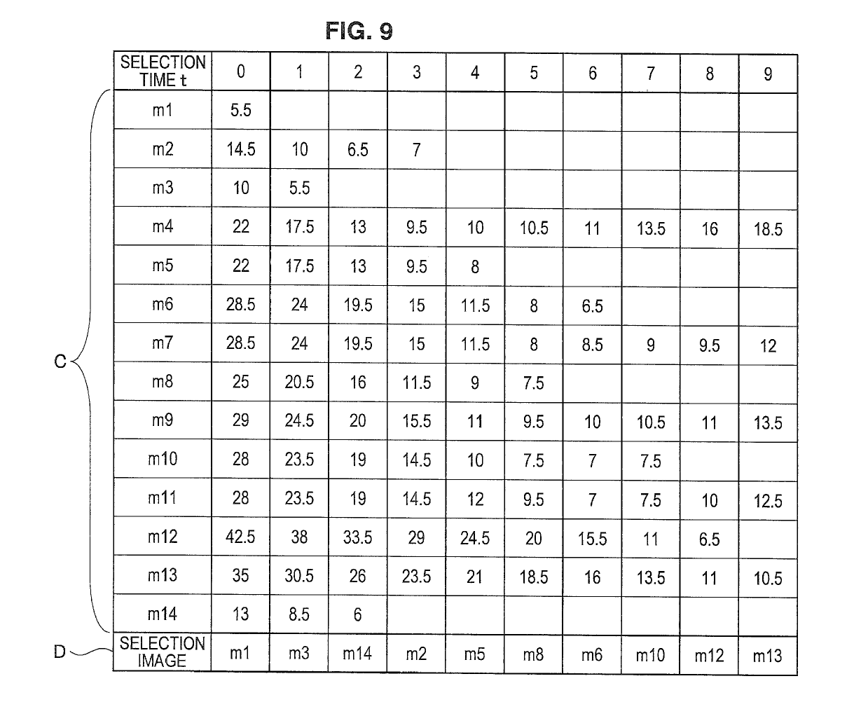

FIG. 9 is an explanatory diagram illustrating another example of the image selection processing in the editing apparatus 100 according to an embodiment of the present disclosure. Here, similar to FIG. 8, FIG. 9 illustrates evaluation values (“C” illustrated in FIG. 9) calculated per selection time “t” and selection images (“D” in FIG. 9) selected per selection time “t” by applying the stories indicated by Equations 1 to 3 to the candidate images m1 through m14 illustrated in FIG. 2.

As illustrated in FIG. 9, the editing apparatus 100 can exclude candidate images once selected as a selection image and select a selection image from candidate images after the exclusion. By selecting a selection image as illustrated in FIG. 9, since the same candidate image is prevented from being selected as a selection image, the editing apparatus 100 can generate more versatile images than in a case where the possessing illustrated in FIG. 9 is performed.

According to the above method, it is possible to reliably select a selection image along a story from multiple candidate images. Meanwhile, there is assumed a case where, depending on a selection time, there is no candidate image matching an expectation value. For example, in the example illustrated in FIG. 5, a suitable candidate image is not provided in a close position at selection time t=6. Although the closest material to the expectation value at selection time t=6 is candidate image F, candidate image C has almost the same distance from the expectation value at selection time t=6 as that of candidate image F. However, since both material C and material F are separated by a distance from the expectation value at time t=6, even if any of candidate image C and candidate image F is selected, it does not follow that a suitable image along a story is not selected.

Therefore, in the present embodiment, by manufacturing candidate image F and make it close to the expectation value of the story at selection time t=6, it is possible to select an optimum material at selection time t=6. Thus, by realizing processing of making a candidate image, which is separated from an expectation value of a story, close to an expectation value of a candidate image, it is possible to select a selection image suitable to the story.

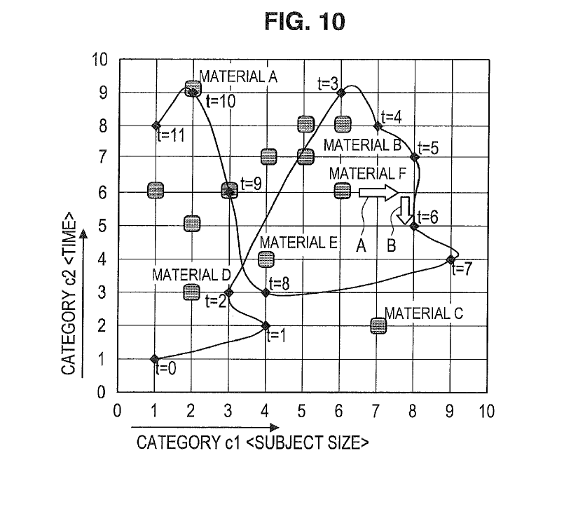

An explanation is given blow in detail. For example, it is assumed that category c1 denotes a “photographed subject size” and category c2 denotes a “photographing time.” Also, it is assumed that the subject size becomes larger as the feature value becomes larger in category c1 and the photographing time on the time axis advances as the feature value becomes larger in category c2. As described above, in FIG. 5, candidate image C is separated from the expectation value of the story at selection time t=6. In this case, from the viewpoint of category c1 (i.e. subject size), the expectation value at selection time t6 is 8 and a subject candidate image which is photographed in a relatively large size is desirable, but the feature value of candidate image F is 6, that is, the subject is not photographed in a relatively large size. Therefore, the peripheral part of the image of candidate image F is cut out and trimmed, and, as a result of this, the subject is zoomed up and enlarged. In this way, as illustrated by arrow A in FIG. 10, candidate image F becomes close to the expectation value of the story at selection time t=6.

Also, in a case where candidate image F is a moving image, by advancing the timing of cutting out an image on the time axis, it is possible to advance the photographing time of category c2 on the time axis. In this way, as illustrated by arrow B in FIG. 10, it is possible to make material F closer to the expectation value at selection time t=6.

First, by the above method, a candidate image at selection time t=6 is found. The score of a candidate image is expressed as S(m, c1) with respect to category c1 and S(m,c2) with respect to category c2. In the case of candidate image F illustrated in FIG. 5, S(m,c1) is 6 and S(m,c2) is 6. Also, as illustrated in FIG. 5, the score expectation value at selection time t=6 has SX(c1,t)=8 and SX(c2,t)=5. When the distance between the score expectation value and the actual score is calculated by the Manhattan distance, D(M)(t)=D(m,t)=3 is established as described below.

$$D ( m , t ) = {\sum }_{n}^{ } \vert S ( m , cn ) - SX ( cn , t ) \vert = \vert 6 - 8 \vert + \vert 6 - S \vert = 3$$

Further, c1<c2 is set as a category priority. The most suitable material is D(m,t)=0 and it is desirable to provide D(m,t)=0 as much as possible. According to the category priority, since c1 is lower, first, category c1 is focused to perform an adjustment so as to provide D=0. In other words, in the case of adjusting a feature value of a candidate image, the adjustment is performed in order from the category of the lower priority. Since category c1 denotes the “subject zoom-up degree,” S(m,c1) may be made closer to SX(c1,t) in order to shorten the distance associated with c1. That is, the value of S(m,c1) may be made closer to “8.”

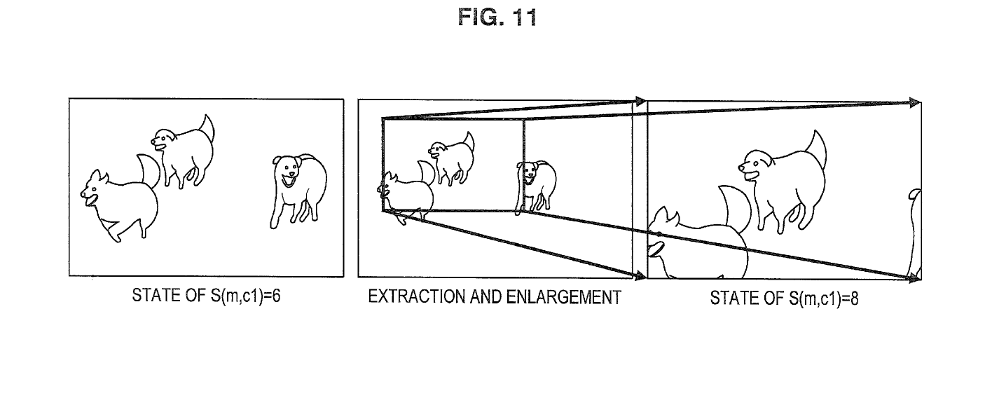

As described above, it is assumed that, as the value of S(m,c1) becomes larger, the subject size becomes larger. When the value of S(m,c1) is made close to “8” from “6,” the subject size is enlarged. Therefore, by cropping and zooming up a screen of candidate image F as illustrated in FIG. 11, it is possible to make the value of S(m,c1) close to “8.”

Meanwhile, even if the value of S(m,c1) is larger than the value of SX(c1,t), candidate image F is requested to be reduced, but, in a case where the reduction is performed, there is no peripheral image (i.e. margin image). Therefore, in a case where the value of S(m,c1) is larger than the value of SX(c1,t), a category of the next lower priority is focused. That is, in this example, category c2 is focused.

Since category c2 denotes the “photographing time,” the photographing time of candidate image F is changed to change the value. Here, when candidate image F is acquired from a moving image, the time at which candidate image F is picked up is changed. To be more specific, by advancing the timing of cutting out candidate image F in the moving image on the time axis, it is possible to advance the photographing time of category c2 on the time axis. In this way, it is possible to change the value of S(m,c2) from “6” to “5.” Here, in the case of a moving image, generally, when materials at different photographing times are used, since photographed subjects or structures change, it is assumed that other parameters than the time change. Therefore, other parameters may be reevaluated. As described above, by changing the subject size and photographing time of candidate image F, it is possible to make the candidate image F match an expectation value of a story.

### [Example of Image Selection Processing]

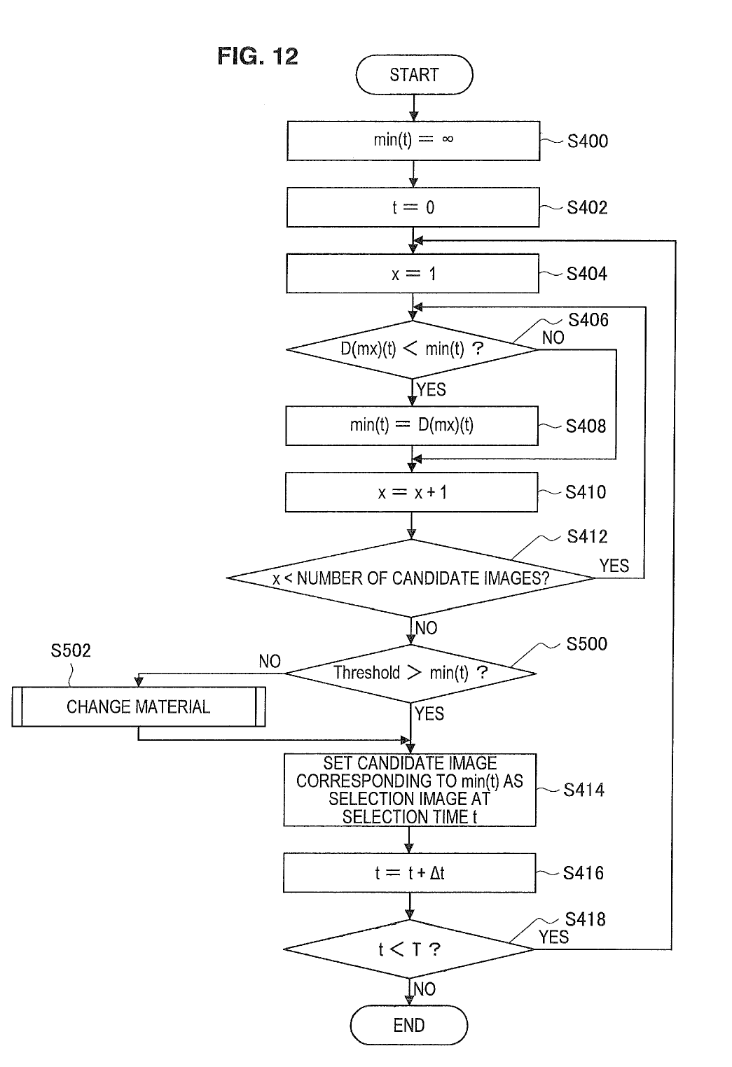

Here, image selection processing in the editing apparatus 100 according to an embodiment of the present disclosure is explained in more detail. FIG. 12 is a flowchart indicating an example of the image selection processing in the editing apparatus 100 according to an embodiment of the present disclosure. Here, FIG. 12 illustrates an example of image selection processing in a case where the editing apparatus 100 calculates Manhattan distance D(M)(t) based on both a feature value of a candidate image (M) and an expectation value of the candidate image shown in Equation 1 as an evaluation value at selection time t. Also, as illustrated in FIG. 8, FIG. 12 illustrates an example of the image selection processing in which the same candidate image can be selected as a selection image at multiple selection times t. Further, FIG. 12 illustrates processing in a case where, when there are multiple candidate images having the same evaluation value, a candidate image processed earlier is preferentially selected as a selection image.

The editing apparatus 100 sets min(t)=00 as a value of minimum value min(t) of an evaluation value (or Manhattan distance) at selection time t (S400). Alternatively, min(t)=P (where P is a predetermined value) or min(t)=0 may be set. Also, similar to steps S300 and S302 in FIG. 7, the editing apparatus 100 sets t=0 as a value of selection time t (S402) and x=1 as a value of x to define a candidate image for which an evaluation value is calculated (S404).

When the processing in step S404 is performed, the editing apparatus 100 decides whether the value of evaluation value D(mx)(t) is smaller than min(t) (S406). In a case where it is not decided in step S406 that the value of evaluation value D(mx)(t) is smaller than min(t), the editing apparatus 100 executes processing in step S410 to be described later.

In a case where it is decided in step S406 that the value of evaluation value D(mx)(t) is smaller than min(t), the editing apparatus 100 updates the value of min(t) to min(t)=D(mx)(t) (S408).

In a case where it is not decided in step S406 that the value of evaluation value D(mx)(t) is not smaller than min(t) or the processing in step S408 is performed, the editing apparatus 100 updates the value of “x” to “x+1” (S410).

When the value of “x” is updated in step S410, the editing apparatus 100 decides whether the value of “x” is smaller than the number of candidate images (S412). In a case where it is decided in step S412 that the value of “x” is smaller than the number of candidate images, the editing apparatus 100 repeats the processing in step S406 therefrom.

Also, in a case where it is not decided in step S412 that the value of “x” is smaller than the number of candidate images, whether the value of min(t) is smaller than a predetermined threshold (Threshold) is decided (S500). Subsequently, in a case where the value of min(t) is equal to or larger than the predetermined threshold, change processing of a candidate image (or material) is performed (S502). In step S502, as described above, processing of changing a material in preferential order from a lower category is performed so as to become close to an expectation value, an evaluation value of a changed candidate image is newly set as min(t). After step S502, the flow proceeds to step S414.

Also, in a case where the value of min(t) is smaller than the predetermined threshold in step S500, the flow proceeds to step S414. In step S414, the editing apparatus 100 sets a candidate image corresponding to min(t) as a selection image at selection time “t” (S414).

When the processing in step S414 is performed, the editing apparatus 100 updates the value of “t” to “t+Δt” (S416). Subsequently, the editing apparatus 100 decides whether the value of “t” is smaller than total reproduction time T of an edited image (S418).

In a case where it is decided in step S418 that the value of “t” is smaller than total reproduction time T, the editing apparatus 100 repeats the processing in step S404 therefrom. Also, in a case where it is not decided in step S418 that the value of “t” is smaller than total reproduction time T, the editing apparatus 100 terminates the image selection processing.

For example, by performing the processing illustrated in FIG. 12, the editing apparatus 100 selects a candidate image having the minimum evaluation value (i.e. a candidate image having a higher evaluation) at each selection time as the selection image at each selection time. Here, it is needless to say that the image selection processing according to an embodiment of the present disclosure is not limited to the example illustrated in FIG. 12.

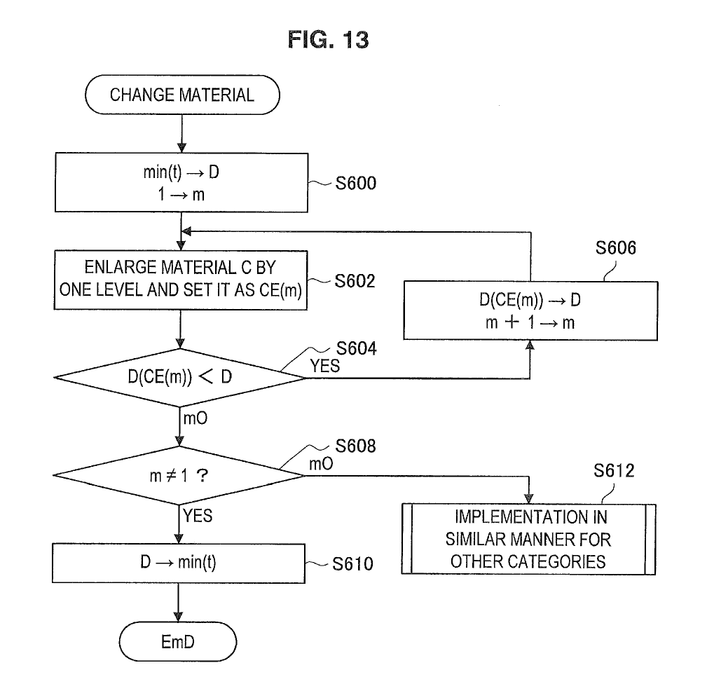

FIG. 13 is a flowchart illustrating the material change processing in step S502 in FIG. 12. Here, similar to the example in FIG. 10, an explanation is given to a case where a candidate image zoom-up ratio (i.e. enlargement ratio) is changed to change a material character. In step S600, it is candidate image F that corresponds to min(t). First, in step S600, the minimum evaluation value of candidate image F is set as min(t)=D, m=1. Here, “m” denotes a numerical value indicating how much stages the candidate image is changed. Next, in step S602, an image acquired by enlarging (or zooming up) the image of candidate image F by one level is referred to as CE(m).

In next step S604, regarding evaluation value D(CE(m)) indicating the distance between CE(m) and an expectation value at selection time t, whether D(CE(m))<D is established is decided. In the case of D(CE(m))<D, the flow proceeds to step S606 to newly set D(CE(m)), m=m+1, and the flow returns to step S602 to perform the subsequent processing. Thus, in the case of D(CE(m))<D, by repeatedly performing the processing in steps S602, S604 and S606, the value of D(CE(m)) is reduced.

Also, in the case of (CE(m))≧D in step S604, the flow proceeds to step S608 to decide whether m≠1 is established, and, in the case of m≠1, the flow proceeds to step S610. In step S610, min(t)=D is set and the processing is terminated. In this way, the value of min(t) is set to the minimum value calculated in the loop of steps S602, S604 and S606. The value of min(t) set herein is used in processing after step S414 in FIG. 12, and, in step S414, changed candidate image F corresponding to min(t) is set as a selection image at selection time “t.”

Meanwhile, in the case of m=1 in step S608, since the evaluation value of candidate image F is larger than value D set in step S600, it is decided that it is not possible to decrease the evaluation value even if a feature value is changed in category c1, and the calculation after step S600 is implemented in the same way for other categories (S612). For example, in a case where a category of the next lower priority is the “photographing time,” in step S602, the photographing time of candidate image F is changed by one level and the candidate image with the changed photographing time is set as CE(m). Subsequently, similar to the above, in the case of D(CE(m))<D in step S604, the flow proceeds to step S606 to newly set D(CE(m))=D, m=m+1, and the flow returns to step S602 to perform the subsequent processing. Thus, in the case of D(CE(m))<D, the value of D(CE(m)) is reduced. Also, in the case of (CE(m))≧D in step S604, the flow proceeds to step S608, and, in the case of m≠1, the flow proceeds to step S610. In step S610, min(t)=D is set and the processing is terminated.

### [Example of Changing Story]

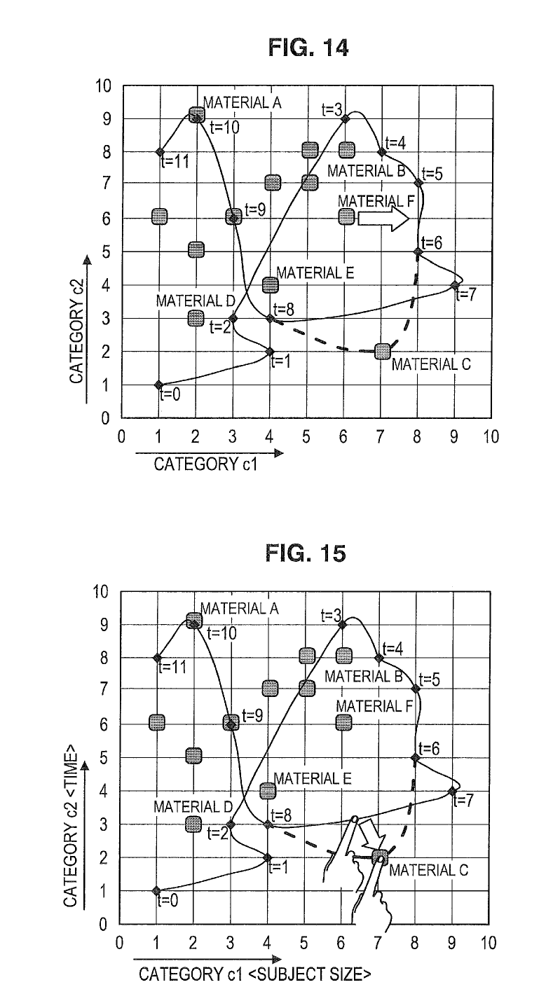

In the above example, in a case where a candidate image (or material) does not match an expectation value of a story, processing is performed such that the material is changed so as to become close to the expectation value. Meanwhile, by changing the story in such a case, it is possible to match the material and the expectation value of the story. FIG. 14 is a pattern diagram illustrating an example of changing the story between selection time t=6 and selection time t=8 in FIG. 3 to the story indicated by dash line in FIG. 14. Thus, the story around selection times t=6 to t=8 is changed according to a story material and connected to a story before and after the selection times. In this way, since the expectation value of the story between selection time t=6 and selection time t=8 matches candidate image C, by selecting candidate image C, it is possible to select a selection image matching the story.

At the time of changing the story, on the display screen as illustrated in FIG. 15, it is desirable to change it using a graphical UI such as a touch panel. In this way, by changing it while watching the screen, it is possible to suppress that the changed story is largely different form the original story.

Based on FIG. 15, a procedure of changing a story using a graphical UI on a display screen is explained. As illustrated in FIG. 15, for example, an explanation is given to an example where the expectation value at t=7 is largely separated from a candidate image and it is difficult to change the candidate image. In this case, the story expectation value itself is changed. At this time, as illustrated in FIG. 15, by showing the story on a graph and changing the curve line of the story by a user operation by a mouse or touch panel, it is possible to change the story itself.

As described above, in a case where a story expectation value and a material score are largely separated, by changing the material or the story, it is possible to select an optimum selection image and edit a creation along the story.

Also, in the above explanation, although a case has been exemplified where there are two categories for ease of explanation, there may be provided more categories. Even in this case, by the same procedure as in the case of two categories, it is possible to apply an optimum material. In the example in FIG. 15, although it is complicated to perform a display when there are provided many categories, if the user selects two categories to be changed from multiple categories or selects two categories in which a material is likely to be provided near a story, it is possible to generate a two-dimensional graph. Subsequently, by performing an operation on the graph, it is possible to change the story in a graphical manner.

Next, with reference to FIG. 1 again, an explanation is given to an example of processing according to the editing approach in the editing apparatus 100 according to an embodiment of the present disclosure. When a selection image per selection time is selected in step S106, the editing apparatus 100 performs an edit by linking the selection images in chronological order (S108: edit processing).

For example, by performing the processing illustrated in FIG. 1, the editing apparatus 100 can sequentially calculate an evaluation value per selection time, based on a story indicated by a time function and the feature value set for each candidate image, and set a candidate image of the minimum evaluation value (or candidate image of a higher evaluation) per selection time as a selection image per selection time. Therefore, for example, by performing the processing illustrated in FIG. 1, the editing apparatus 100 can prevent a selection image from being unselected in each selection time, which may be caused in a case where an automatic edit is performed using the related art or a story template. Therefore, for example, by performing the processing illustrated in FIG. 1, the editing apparatus 100 can select an image corresponding to a story from multiple candidate images per selection time for image selection and edit the selected image. Here, it is needless to say that the processing associated with the editing approach according to an embodiment of the present disclosure is not limited to the example illustrated in FIG. 1.

Also, although an explanation has been described above where the editing apparatus 100 performs the processing associated with the editing approach according to an embodiment of the present disclosure, it is not limited that the processing associated with the editing approach according to an embodiment of the present disclosure is realized by one apparatus. For example, the processing associated with the editing approach according to an embodiment of the present disclosure (i.e. the processing according to the editing method according to an embodiment of the present disclosure) may be realized by, for example, a system (or editing system) presumed to be connected to a network such as cloud computing.

### (Editing Apparatus According to Embodiment of the Present Disclosure)

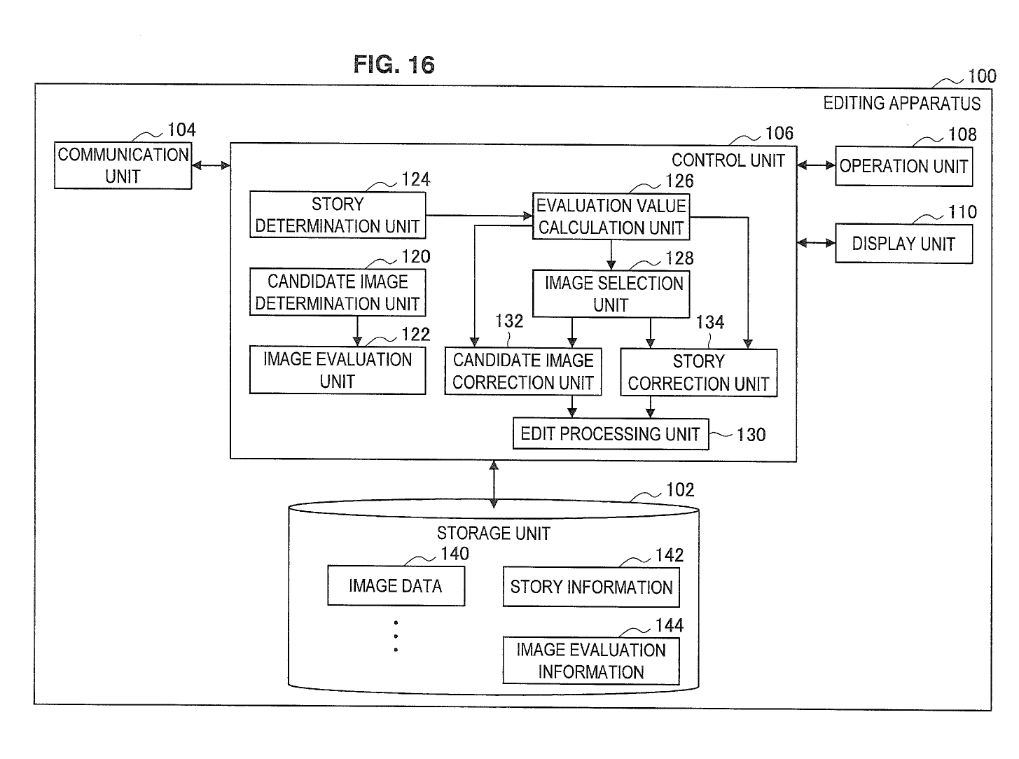

Next, an explanation is given to a configuration example of the editing apparatus 100 according to an embodiment of the present disclosure, where the editing apparatus can perform processing associated with the editing approach according to an embodiment of the present disclosure. FIG. 16 is a block diagram illustrating a configuration example of the editing apparatus 100 according to an embodiment of the present disclosure.

With reference to FIG. 16, the editing apparatus 100 includes, for example, a storage unit 102, a communication unit 104, a control unit 106, an operation unit 108 and a display unit 110.

Also, for example, the editing apparatus 100 may include a ROM (Read Only Memory (not illustrated)) and a RAM (Random Access Memory (not illustrated)). For example, the editing apparatus 100 connects the components by buses as data channels. Here, the ROM (not illustrated) stores, for example, control data such as programs and computation parameters used in the control unit 106. The RAM (not illustrated) temporarily stores, for example, a program executed by the control unit 106.

### [Hardware Configuration Example of Editing Apparatus 100]

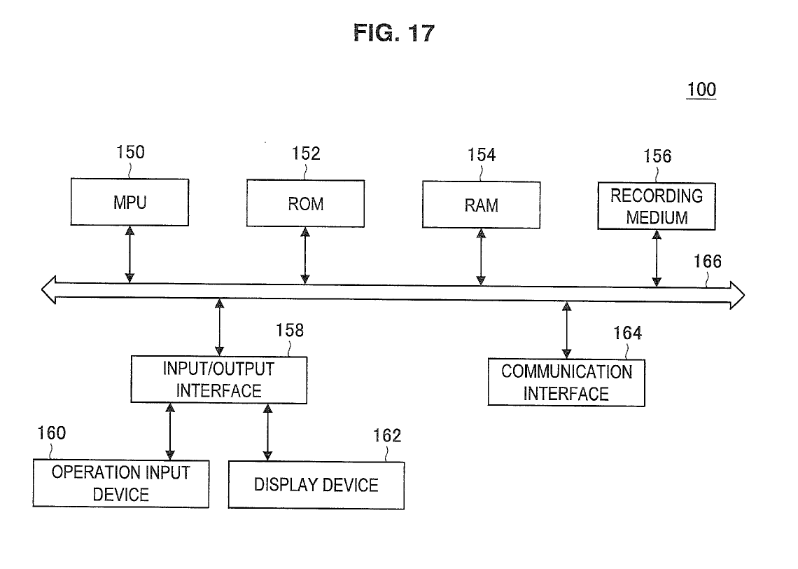

FIG. 17 is an explanatory diagram illustrating an example of a hardware configuration of the editing apparatus 100 according to an embodiment of the present disclosure. With reference to FIG. 17, the editing apparatus 100 includes, for example, an MPU 150, a ROM 152, a RAM 154, a recording medium 156, an input/output interface 158, an operation input device 160, a display device 162 and a communication interface 164. Also, for example, the editing apparatus 100 connects the components by a bus 166 as a data channel.

The MPU 150 is formed with an MPU (Micro Processing Unit), an integrated circuit integrating multiple circuits to realize a control function, and so on, and functions as the control unit 106 to control the whole of the editing apparatus 100. Also, in the editing apparatus 100, the MPU 150 can play a role as a candidate image determination unit 120, an image evaluation unit 122, a story determination unit 124, an evaluation value calculation unit 126, an image selection unit 128 and an edit processing unit 130, which are described later.

The ROM 152 stores control data such as programs and computation parameters used in the MPU 150. For example, the RAM 154 temporarily stores a program executed by the MPU 150.

The recording medium 156 functions as the storage unit 102 and stores, for example, image data, story information, image evaluation information recording image feature values as illustrated in FIG. 2, applications, and so on. Here, examples of the recording medium 156 include a magnetic recording medium such as a hard disk, and a nonvolatile memory such as an EEPROM (Electrically Erasable and Programmable Read Only Memory), a flash memory, an MRAM (Magnetoresistive Random Access Memory), a FeRAM (Ferroelectric Random Access Memory) and a PRAM (Phase change Random Access Memory). Also, the editing apparatus 100 can include the recording medium 156 that is detachable from the editing apparatus 100.

The input/output interface 158 connects, for example, the operation input device 160 and the display device 162. The operation input device 160 functions as the operation unit 108 and the display device 162 functions as the display unit 110. Here, examples of the input/output interface 158 include a USB (Universal Serial Bus) terminal, a DVI (Digital Visual Interface) terminal, an HDMI (High-Definition Multimedia Interface) terminal and various processing circuits. Also, for example, the operation input device 160 is provided on the editing apparatus 100 and connected to the input/output interface 158 in the editing apparatus 100. Examples of the operation input device 160 include a button, a cursor key, a rotary selector such as a jog dial, and their combination. Also, for example, the display device 162 is provided on the editing apparatus 100 and connected to the input/output interface 158 in the editing apparatus 100. Examples of the display device 162 include a liquid crystal display (LCD), an organic EL display (i.e. organic ElectroLuminescence display, which may be referred to as “OLED display” (i.e. Organic Light Emitting Diode display)). Also, it is needless to say that the input/output interface 158 can connect to an operation input device (such as a keyboard and a mouse) or display device (such as an external display) as an external apparatus of the editing apparatus 100. Also, the display device 162 may be a device in which a display and a user operation are possible, such as a touch screen.

The communication interface 164 is a communication unit held in the editing apparatus 100 and functions as the communication unit 104 to perform wireless/wire communication with an external apparatus such as a server via a network (or in a direct manner). Here, examples of the communication interface 164 include a communication antenna and an RF circuit (wireless communication), an IEEE802.15.1 port and a transmission/reception circuit (wireless communication), an IEEE802.11b port and a transmission/reception circuit (wireless communication), and a LAN terminal and a transmission/reception circuit (wire communication). Also, examples of a network according to an embodiment of the present disclosure include a wire network such as a LAN (Local Area Network) and a WAN (Wide Area Network), a wireless network such as a wireless WAN (WWAN: Wireless Wide Area Network) through a base station, and the Internet using a communication protocol such as TCP/IP (Transmission Control Protocol/Internet Protocol).

For example, by the configuration illustrated in FIG. 17, the editing apparatus 100 performs processing associated with the editing approach according to an embodiment of the present disclosure. Also, a hardware configuration of the editing apparatus 100 according to an embodiment of the present disclosure is not limited to the configuration illustrated in FIG. 17. For example, the editing apparatus 100 may include a DSP (Digital Signal Processor) and a sound output device formed with an amplifier (i.e. amp) and a speaker. In the above case, for example, by outputting an error sound from the above sound output device in step S208 in FIG. 6, the editing apparatus 100 can audibly report an error. Also, for example, the editing apparatus 100 may employ a configuration without the operation input device 160 and the display device 162 illustrated in FIG. 17.

With reference to FIG. 16 again, a configuration of the editing apparatus 100 according to an embodiment of the present disclosure is explained. The storage unit 102 denotes a storage unit held in the editing apparatus 100. Here, examples of the storage unit 102 include a magnetic recording medium such as a hard disk, and a nonvolatile memory such as a flash memory.

Also, the storage unit 102 stores, for example, image data, story information, image evaluation information and applications. Here, FIG. 16 illustrates an example where the storage unit 102 stores image data 140, story information 142 and image evaluation information 144.

The communication unit 104 denotes a communication unit held in the editing apparatus 100 and performs wireless/wire communication with an external apparatus such as a server via a network (or in a direct manner). Also, in the communication unit 104, for example, communication is controlled by the control unit 106.

Here, as the communication unit 104, a communication antenna and an RF circuit, and a LAN terminal and a transmission/reception circuit are provided as an example, but the configuration of the communication unit 104 is not limited to the above. For example, the communication unit 104 can employ an arbitral configuration in which communication is possible with an external apparatus via a network.

The control unit 106 is formed with an MPU, an integrated circuit integrating multiple circuits to realize a control function, and so on, and plays a role to control the whole of the editing apparatus 100. Also, the control unit 106 includes a candidate image determination unit 120, an image evaluation unit 122, a story determination unit 124, an evaluation value calculation unit 126, an image selection unit 128, a candidate image correction unit 132, a story correction unit 134 and an edit processing unit 130, and plays a leading role to perform processing associated with the editing approach according to an embodiment of the present disclosure. Also, the control unit 106 may include a communication control unit (not illustrated) to control communication with an external apparatus such as a server.

The candidate image determination unit 120 determines a candidate image based on a user operation. To be more specific, the candidate image determination unit 120 plays a leading role to perform the processing in step S100 illustrated in FIG. 1, for example.

The image evaluation unit 122 sets a feature value with respect to a candidate image based on the candidate image. To be more specific, for example, every time a candidate image is determined in the candidate image determination unit 120, by performing an image analysis of the determined candidate image and referring to metadata of the candidate image, the image evaluation unit 122 sets the feature value for each candidate image. Subsequently, for example, the image evaluation unit 122 generates image evaluation information and records it in the storage unit 102. Also, in a case where the image evaluation information is stored in the storage unit 102, the image evaluation information may be overwritten and updated or may be separately recorded. Also, processing in the image evaluation unit 122 is not limited to the above. For example, the image evaluation unit 122 may set a feature value to image data stored in the storage unit 102 without depending on candidate image determination in the candidate image determination unit 120.

Also, for example, in a case where a candidate image is a moving image having a reproduction time exceeding a predetermined time, the image evaluation unit 122 can divide the candidate image such that the reproduction time falls within the predetermined time, and sets the feature value to each of the divided candidate images.

The story determination unit 124 determines a story. To be more specific, the story determination unit 124 plays a leading role to perform the processing in step S102 illustrated in FIG. 1, for example.

The evaluation value calculation unit 126 calculates the evaluation value of each candidate image per selection time, based on the story determined in the story determination unit 124 and the feature value set for each of multiple candidate images. To be more specific, for example, the evaluation value calculation unit 126 plays a leading role to perform the processing in step S104 illustrated in FIG. 1, using the story determined in the story determination unit 124 and the image evaluation information 144 stored in the storage unit 102.

The image selection unit 128 selects a selection image from candidate images per selection time, based on the evaluation values calculated in the evaluation value calculation unit 126. To be more specific, for example, the image selection unit 128 plays a leading role to perform the processing in step S106 illustrated in FIG. 1.

The candidate image correction unit 132 corrects the selected selection images based on the evaluation values calculated in the evaluation value calculation unit 126. To be more specific, for example, the candidate image correction unit 132 plays a leading role to perform the processing in step S502 illustrated in FIG. 12.

The story correction unit 134 corrects a story based on the evaluation values calculated in the evaluation value calculation unit 126. To be more specific, for example, the story correction unit 134 plays a leading role to perform the processing illustrated in FIG. 14 and FIG. 15, based on an operation performed in the operation unit 108 by the user.

The edit processing unit 130 links the selection images, which are selected per selection time in the image selection unit 128, in chronological order. That is, for example, the edit processing unit 130 plays a leading role to perform the processing in step S108 illustrated in FIG. 1.

The control unit 106 includes, for example, the candidate image determination unit 120, the image evaluation unit 122, the story determination unit 124, the evaluation value calculation unit 126, the image selection unit 128 and the edit processing unit 130, thereby playing a leading role to perform the processing associated with the editing approach. Also, it is needless to say that a configuration of the control unit 106 is not limited to the configuration illustrated in FIG. 15.

The operation unit 108 denotes an operation unit, which allows a user operation and is held in the editing apparatus 100. By holding the operation unit 108, the editing apparatus 100 can allow a user operation and perform processing desired by the user according to the user operation. Here, examples of the operation unit 108 include a button, a cursor key, a rotary selector such as a jog dial, and their combination.

The display unit 110 denotes a display unit held in the editing apparatus 100 and displays various kinds of information on a display screen. Examples of a screen displayed on the display screen of the display unit 110 include an error screen to visually report an error in step S208 in FIG. 6, a reproduction screen to display an image indicated by image data, and an operation screen to cause the editing apparatus 100 to perform a desired operation. Also, examples of the display unit 110 include an LCD and an organic EL display. Here, the editing apparatus 100 can form the display unit 110 with a touch screen. In the above case, the display unit 110 functions as an operation display unit that allows both a user operation and a display.

For example, by the configuration illustrated in FIG. 16, the editing apparatus 100 can realize the processing associated with the editing approach according to an embodiment of the present disclosure as illustrated in FIG. 1, for example. Therefore, for example, by the configuration illustrated in FIG. 16, the editing apparatus 100 can select an image corresponding to a story from multiple candidate images per selection time for image selection and edit the selected image. Here, it is needless to say that the configuration of the editing apparatus 100 according to an embodiment of the present disclosure is not limited to the configuration illustrated in FIG. 16.

As described above, the editing apparatus 100 according to an embodiment of the present disclosure sequentially calculates an evaluation value per selection time, based on a story indicated by a time function and the feature value set for each candidate image, and sets a candidate image of the minimum (or maximum) evaluation value (i.e. candidate image of higher evaluation) per selection time, as a selection image per selection time. Therefore, the editing apparatus 100 can prevent a selection image from being unselected in each selection time, which may be caused in a case where an automatic edit is performed using the related art or a story template. Therefore, the editing apparatus 100 can select an image corresponding to a story from multiple candidate images per selection time for image selection and edit the selected image.

Also, the editing apparatus 100 selects a candidate image of high evaluation indicated by a calculated evaluation value as a selection image from multiple candidate images, for example, even in a case where an edit is performed using a indefinitely large number of candidate images, it is possible to select a more suitable selection image along a story. Therefore, for example, even in a case where candidate images dynamically change like a case where images, which are arbitrarily added or deleted by multiple users in an image community site, are processed as candidate images, the editing apparatus 100 can select a more suitable selection image along a story from the candidate images.

Further, since the editing apparatus 100 uses a story indicated by a time function, for example, it is possible to extend or abridge a story according to the setting of selection time. That is, by using a story indicated by a time function, the editing apparatus 100 can extend or abridge the story in an easier manner than a case where, for example, a story template is used in which it is difficult to extend or abridge a story unless the used story template itself is changed. Therefore, by using a story indicated by a time function, the editing apparatus 100 can perform an image edit of higher general versatility.

Although an explanation has been described above using the editing apparatus 100 as an embodiment of the present disclosure, the embodiment of the present disclosure is not limited to this. An embodiment of the present disclosure is applicable to various devices such as a computer including a PC and a server, a display apparatus including a television set, a portable communication apparatus including a mobile phone, an image/music reproduction apparatus (or image/music record reproduction apparatus) and a game machine.

Also, an embodiment of the present disclosure is applicable to a computer group forming a system (e.g. edit system) presumed to be connected to a network such as cloud computing.

### (Program According to Embodiment of the Present Disclosure)

By a program to cause a computer to function as the editing apparatus according to an embodiment of the present disclosure (e.g. a program to realize processing associated with the editing approach according to an embodiment of the present disclosure as illustrated in FIG. 1, FIG. 6, FIG. 7, FIG. 12 and FIG. 13), it is possible to select an image corresponding to a story from multiple candidate images per selection time for image selection and edit the selected image.

### (Recording Medium Recording Program According to Embodiment of the Present Disclosure)

Also, a case has been described above where a program (or computer program) to cause a computer to function as a control apparatus according to an embodiment of the present disclosure is provided, but, according to an embodiment of the preset disclosure, it is possible to further provide a recording medium storing the above program.

It should be understood by those skilled in the art that various modifications, combinations, sub-combinations and alterations may occur depending on design requirements and other factors insofar as they are within the scope of the appended claims or the equivalents thereof.

For example, the editing apparatus 100 according to an embodiment of the present disclosure can include the candidate image determination unit 120, the image evaluation unit 122, the story determination unit 124, the evaluation value calculation unit 126, the image selection unit 128, the edit processing unit 130, the candidate image correction unit 132 and the story correction unit 134 illustrated in FIG. 15, individually (e.g. realize these by respective processing circuits).

The above configuration denotes an example of an embodiment of the present disclosure and naturally belongs to the technical scope of the present disclosure.

Additionally, the present technology may also be configured below.

(1) An editing apparatus including:

a story determination unit determining a story indicated by a time function as a reference to select an image from multiple candidate images;

an evaluation value calculation unit calculating an evaluation value of each of the candidate images per selection time in the story, based on the story determined in the story determination unit and one or more feature values which are set for each of the multiple candidate images and indicate features of the candidate images;

an image selection unit selecting an image per selection time from the candidate images, based on the evaluation value calculated in the evaluation value calculation unit;

a candidate image correction unit correcting the selected candidate image based on the evaluation value; and

an edit processing unit linking the image selected per selection time and the candidate image corrected based on the evaluation value, in chronological order.

(2) The editing apparatus according to (1), wherein the candidate image correction unit corrects the selected candidate image in a case where the evaluation value is equal to or less than a predetermined value.
(3) The editing apparatus according to (2), wherein the candidate image correction unit corrects the selected candidate image in a manner that the evaluation value is equal to or less than a predetermined value.
(4) The editing apparatus according to (3), wherein the candidate image correction unit corrects a magnifying power of the selected candidate image in a manner that the evaluation value is equal to or less than a predetermined value.
(5) The editing apparatus according to (3), wherein the candidate image correction unit corrects a photographing time of the selected candidate image in a manner that the evaluation value is equal to or less than a predetermined value.
(6) An editing apparatus including:

a story determination unit determining a story indicated by a time function as a reference to select an image from multiple candidate images;

an evaluation value calculation unit calculating an evaluation value of each of the candidate images per selection time in the story, based on the story determined in the story determination unit and one or more feature values which are set for each of the multiple candidate images and indicate features of the candidate images;

an image selection unit selecting an image per selection time from the candidate images, based on the evaluation value calculated in the evaluation value calculation unit;

a story correction unit correcting the story based on the evaluation value; and

an edit processing unit linking the image selected per selection time in chronological order.

(7) The editing apparatus according to (6), wherein the story correction unit corrects the story in a case where the evaluation value is equal to or less than a predetermined value.
(8) The editing apparatus according to (6), wherein the story correction unit corrects the story based on a user operation.
(9) The editing apparatus according to (6), wherein the story correction unit corrects the story in a manner that the evaluation value is equal to or less than a predetermined value.
(10) The editing apparatus according to any one of (1) to (9), wherein the evaluation value calculation unit calculates, per selection time, a distance based on a feature value of the candidate image and an expectation value of the feature value of the candidate image as the evaluation value.
(11) The editing apparatus according to (10), wherein the image selection unit selects a candidate image in which the evaluation value per selection time is minimum, per selection time.
(12) The editing apparatus according to any one of (1) to (11), further including:

an image evaluation unit setting the feature value with respect to the candidate image, based on the candidate image.

(13) The editing apparatus according to (12), wherein, in a case where the candidate image is a moving image having a reproduction time over a predetermined time, the image evaluation unit divides the candidate image in a manner that the reproduction time falls within the predetermined time, and sets the feature value to each of the divided candidate images.
(14) The editing apparatus according to any one of (1) to (13), where the story is indicated by a time function using a feature value indicating a feature amount of an image.
(15) An editing method including:

determining a story indicated by a time function as a reference to select an image from multiple candidate images;

calculating an evaluation value of each of the candidate images per selection time in the story, based on the story determined in the determination step and one or more feature values which are set for each of the multiple candidate images and indicate features of the candidate images;

selecting an image per selection time from the candidate images, based on the evaluation value calculated in the calculation step;

correcting the selected candidate image based on the evaluation value; and

linking the image selected per selection time and the candidate image corrected based on the evaluation value, in chronological order.

(16) An editing method including:

determining a story indicated by a time function as a reference to select an image from multiple candidate images;

calculating an evaluation value of each of the candidate images per selection time in the story, based on the story determined in the determination step and one or more feature values which are set for each of the multiple candidate images and indicate features of the candidate images;

selecting an image per selection time from the candidate images, based on the evaluation value calculated in the calculation step;

correcting the story based on the evaluation value; and linking the image selected per selection time in chronological order.

(17) A program for causing a computer to function as:

a unit determining a story indicated by a time function as a reference to select an image from multiple candidate images;

a unit calculating an evaluation value of each of the candidate images per selection time in the story, based on the story determined in the determination step and one or more feature values which are set for each of the multiple candidate images and indicate features of the candidate images;

a unit selecting an image per selection time from the candidate images, based on the evaluation value calculated in the calculation step;

a unit correcting the selected candidate image based on the evaluation value; and

a unit linking the image selected per selection time and the candidate image corrected based on the evaluation value, in chronological order.

(18) A program for causing a computer to function as:

a unit determining a story indicated by a time function as a reference to select an image from multiple candidate images;

a unit calculating an evaluation value of each of the candidate images per selection time in the story, based on the story determined in the determination step and one or more feature values which are set for each of the multiple candidate images and indicate features of the candidate images;

a unit selecting an image per selection time from the candidate images, based on the evaluation value calculated in the calculation step;

a unit correcting the story based on the evaluation value; and

a unit linking the image selected per selection time in chronological order.

(19) A computer-readable recording medium having a program recorded thereon, the program causing a computer to function as:

a unit determining a story indicated by a time function as a reference to select an image from multiple candidate images;

a unit calculating an evaluation value of each of the candidate images per selection time in the story, based on the determined story and one or more feature values which are set for each of the multiple candidate images and indicate features of the candidate images;

a unit selecting an image per selection time from the candidate images, based on the evaluation value calculated in the calculation step;

a unit correcting the selected candidate image based on the evaluation value; and

a unit linking the image selected per selection time and the candidate image corrected based on the evaluation value, in chronological order.

(20) A computer-readable recording medium having a program recorded thereon, the program causing a computer to function as:

a unit determining a story indicated by a time function as a reference to select an image from multiple candidate images;

a unit calculating an evaluation value of each of the candidate images per selection time in the story, based on the determined story and one or more feature values which are set for each of the multiple candidate images and indicate features of the candidate images;

a unit selecting an image per selection time from the candidate images, based on the evaluation value calculated in the calculation step;

a unit correcting the story based on the evaluation value; and

a unit linking the image selected per selection time in chronological order.

The present disclosure contains subject matter related to that disclosed in Japanese Priority Patent Application JP 2012-155711 filed in the Japan Patent Office on Jul. 11, 2012, the entire content of which is hereby incorporated by reference.

What is claimed is:

1. An editing apparatus comprising:
a story determination unit determining a story indicated by a time function as a reference to select an image from multiple candidate images;
an evaluation value calculation unit calculating an evaluation value of each of the candidate images per selection time in the story, based on the story determined in the story determination unit and one or more feature values which are set for each of the multiple candidate images and indicate features of the candidate images;
an image selection unit selecting an image per selection time from the candidate images, based on the evaluation value calculated in the evaluation value calculation unit;
a candidate image correction unit correcting the selected candidate image based on the evaluation value; and
an edit processing unit linking the image selected per selection time and the candidate image corrected based on the evaluation value, in chronological order.

2. The editing apparatus according to claim 1, wherein the candidate image correction unit corrects the selected candidate image in a case where the evaluation value is equal to or less than a predetermined value.

3. The editing apparatus according to claim 2, wherein the candidate image correction unit corrects the selected candidate image in a manner that the evaluation value is equal to or less than a predetermined value.

4. The editing apparatus according to claim 3, wherein the candidate image correction unit corrects a magnifying power of the selected candidate image in a manner that the evaluation value is equal to or less than a predetermined value.

5. The editing apparatus according to claim 3, wherein the candidate image correction unit corrects a photographing time of the selected candidate image in a manner that the evaluation value is equal to or less than a predetermined value.

6. An editing apparatus comprising:
a story determination unit determining a story indicated by a time function as a reference to select an image from multiple candidate images;
an evaluation value calculation unit calculating an evaluation value of each of the candidate images per selection time in the story, based on the story determined in the story determination unit and one or more feature values which are set for each of the multiple candidate images and indicate features of the candidate images;
an image selection unit selecting an image per selection time from the candidate images, based on the evaluation value calculated in the evaluation value calculation unit;
a story correction unit correcting the story based on the evaluation value; and
an edit processing unit linking the image selected per selection time in chronological order.

7. The editing apparatus according to claim 6, wherein the story correction unit corrects the story in a case where the evaluation value is equal to or less than a predetermined value.

8. The editing apparatus according to claim 6, wherein the story correction unit corrects the story based on a user operation.

9. The editing apparatus according to claim 6, wherein the story correction unit corrects the story in a manner that the evaluation value is equal to or less than a predetermined value.

10. The editing apparatus according to claim 1, wherein the evaluation value calculation unit calculates, per selection time, a distance based on a feature value of the candidate image and an expectation value of the feature value of the candidate image as the evaluation value.

11. The editing apparatus according to claim 10, wherein the image selection unit selects a candidate image in which the evaluation value per selection time is minimum, per selection time.

12. The editing apparatus according to claim 1, further comprising:
an image evaluation unit setting the feature value with respect to the candidate image, based on the candidate image.

13. The editing apparatus according to claim 12, wherein, in a case where the candidate image is a moving image having a reproduction time over a predetermined time, the image evaluation unit divides the candidate image in a manner that the reproduction time falls within the predetermined time, and sets the feature value to each of the divided candidate images.

14. The editing apparatus according to claim 1, where the story is indicated by a time function using a feature value indicating a feature amount of an image.

15. An editing method comprising:
determining a story indicated by a time function as a reference to select an image from multiple candidate images;
calculating an evaluation value of each of the candidate images per selection time in the story, based on the story determined in the determination step and one or more feature values which are set for each of the multiple candidate images and indicate features of the candidate images;
selecting an image per selection time from the candidate images, based on the evaluation value calculated in the calculation step;
correcting the selected candidate image based on the evaluation value; and
linking the image selected per selection time and the candidate image corrected based on the evaluation value, in chronological order.

16. An editing method comprising:
determining a story indicated by a time function as a reference to select an image from multiple candidate images;
calculating an evaluation value of each of the candidate images per selection time in the story, based on the story determined in the determination step and one or more feature values which are set for each of the multiple candidate images and indicate features of the candidate images;
selecting an image per selection time from the candidate images, based on the evaluation value calculated in the calculation step;
correcting the story based on the evaluation value; and
linking the image selected per selection time in chronological order.

17. A program for causing a computer to function as:
a unit determining a story indicated by a time function as a reference to select an image from multiple candidate images;
a unit calculating an evaluation value of each of the candidate images per selection time in the story, based on the story determined in the determination step and one or more feature values which are set for each of the multiple candidate images and indicate features of the candidate images;
a unit selecting an image per selection time from the candidate images, based on the evaluation value calculated in the calculation step;
a unit correcting the selected candidate image based on the evaluation value; and
a unit linking the image selected per selection time and the candidate image corrected based on the evaluation value, in chronological order.

18. A program for causing a computer to function as:
a unit determining a story indicated by a time function as a reference to select an image from multiple candidate images;
a unit calculating an evaluation value of each of the candidate images per selection time in the story, based on the story determined in the determination step and one or more feature values which are set for each of the multiple candidate images and indicate features of the candidate images;
a unit selecting an image per selection time from the candidate images, based on the evaluation value calculated in the calculation step;
a unit correcting the story based on the evaluation value; and
a unit linking the image selected per selection time in chronological order.

19. A computer-readable recording medium having a program recorded thereon, the program causing a computer to function as:
a unit determining a story indicated by a time function as a reference to select an image from multiple candidate images;
a unit calculating an evaluation value of each of the candidate images per selection time in the story, based on the determined story and one or more feature values which are set for each of the multiple candidate images and indicate features of the candidate images;
a unit selecting an image per selection time from the candidate images, based on the evaluation value calculated in the calculation step;
a unit correcting the selected candidate image based on the evaluation value; and
a unit linking the image selected per selection time and the candidate image corrected based on the evaluation value, in chronological order.

20. A computer-readable recording medium having a program recorded thereon, the program causing a computer to function as:
a unit determining a story indicated by a time function as a reference to select an image from multiple candidate images;
a unit calculating an evaluation value of each of the candidate images per selection time in the story, based on the determined story and one or more feature values which are set for each of the multiple candidate images and indicate features of the candidate images;
a unit selecting an image per selection time from the candidate images, based on the evaluation value calculated in the calculation step;
a unit correcting the story based on the evaluation value; and
a unit linking the image selected per selection time in chronological order.
